(19) United States
(12) Patent Application Publication
(10) Pub. No.: US 2011/0024344 A1
(43) Pub. Date: Feb. 3, 2011

(54) NO FILTER NO RUN FLUID FILTRATION SYSTEM

(75) Inventors: Chad M. Thomas, Cookeville, TN (US); Mark J. Johnson, Cookeville, TN (US)

Correspondence Address: HAMRE, SCHUMANN, MUELLER & LARSON, P.C., P.O. BOX 2902, MINNEAPOLIS, MN, 55402-0902, US

(73) Assignee: CUMMINS FILTRATION IP, INC., Minneapolis, MN (US)

(21) Appl. No.: 12/849,372

(22) Filed: Aug. 3, 2010

Related U.S. Application Data
(60) Provisional application No. 61/230,796, filed on Aug. 3, 2009.

(51) Int. Cl. B01D 35/30; B01D 35/157

(52) U.S. Cl. 210/235; 210/435; 210/232; 55/495

(57) ABSTRACT

An upper endcap of a fuel filter cartridge includes a skirt, an axially extending pin surrounded by the skirt, and a plurality of ribs that define fluid flow channels leading to the pin. The pin is extendable through an axially facing fluid opening disposed on a filter head for actuating a valve to an open position allowing fluid to flow through the axially facing opening and exit from a fluid outlet opening. The valve can include a hole that receives the pin therein to help stabilize the valve when the valve is actuated open.

This application claims the benefit of U.S. Provisional Application No. 61/230,796 filed Aug. 3, 2009, which is incorporated herein by reference in its entirety.

### FIELD

This disclosure generally pertains to the field of filtration, and more particularly to fluid filtration systems and related components designed to safe-guard against damage to components such as fuel injectors and associated fuel components, and system malfunctions resulting from a missing or incorrect fluid filter.

### BACKGROUND

It is known to use a valve in a fuel filter assembly to control fuel flow through the assembly. One example of such a valve in a fuel filter assembly is sometimes referred to as a “no filter, no run” valve, where the valve prevents flow of fuel to the engine or fuel injection system if no fuel filter is installed or if the incorrect fuel filter is installed. In this type of system, not only must a fuel filter be present, but the correct fuel filter must be used, in order to allow fuel to flow past the valve to the engine in sufficient quantities to allow the engine to function properly.

### SUMMARY

Improvements relating to “no filter, no run” fluid filtration systems and components used in such systems are described. In a “no filter, no run” fluid filtration system, fluid flow to a downstream component(s) is prevented if a filter cartridge is not installed, and an appropriately designed filter cartridge is required to be installed in order to permit fluid flow. This safeguards against damage to downstream components and malfunctions of equipment in which the fluid filtration system is used. The type of “no filter, no run” fluid filtration systems that can utilize the described improvements can be a number of systems including, but not limited to, a fuel filtration system, for example on an engine such as a diesel or gasoline engine, a hydraulic fluid filtration system in a hydraulic system, other engine fluid filtration systems on diesel or gasoline engines, as well as filtration systems used in non-engine applications.

As described further herein, a filter cartridge is provided that is designed to actuate a valve that controls fluid flow through an axially facing (facing in the direction of insertion of the filter cartridge) fluid opening on a filter head. At the same time, the filter cartridge is configured to allow fluid to flow past the filter cartridge, through an interior defined in the filter cartridge, and reach the valve, which can be opened to allow the fluid to flow out through a fluid outlet opening. In the case of a fuel system, fuel can flow through the valve and past fluid outlet opening to downstream components, for example the fuel injection equipment and associated fuel system components.

In one embodiment, the filter cartridge includes a filter media, a first endcap and a second endcap. The filter media defines an interior space and has first and second ends. The first and second ends of the filter media are secured to the first and second endcaps, respectively. The first endcap includes a planar section that is connected to the first end of the filter media, where the first endcap is devoid of a central opening. The second endcap includes a planar section that is connected to the second end of the filter media and a fluid passageway. A pin that is connected to the second endcap has a fixed end and a free end. The fixed end of the pin is disposed within the interior space, and the free end is positioned further away from the first endcap than is the fixed end.

With this construction, when the filter cartridge is installed, the pin is positioned and configured to actuate a flow control valve to control fluid flow through an axially facing opening defined in a filter head. Further, fluid can flow through the fluid passageway, past the axially facing fluid opening on its way to downstream components.

The filter head that receives the filter cartridge and the filter housing can be configured in a number of ways, as long as the filter head includes a valve controlling fluid flow through the axially facing fluid opening that is actuated by the pin.

For example, the filer assembly can include a housing body that has a closed end, an open end and a side wall extending from the closed end to the open end, threads on an exterior surface of the side wall adjacent the open end, and a filter head that includes a side wall with threads on an inner surface thereof that are engageable with the threads on the exterior surface. The filter head includes an interior space that is divided into a first space for unfiltered fluid and a second space for filtered fluid. An inlet in the filter head is in communication with the first space, and an outlet in the filter head is in communication with the second space. The filter head includes the axially facing fluid opening that places the interior space in communication with the second space. The axially facing fluid opening has a valve that controls fluid flow through the fluid passageway.

The axially facing fluid opening is disposed at a bottom end of a removable sleeve extending downwardly from the filter head and is sized to receive the valve. The valve is configured to control fluid flow from the interior space of the filter cartridge, through the axially facing fluid opening and exiting from fluid outlet opening defined in the filter head. The valve is axially moveable between a first position preventing fluid flow through the axially facing fluid opening and exiting from the fluid outlet opening defined in the filter head and a second position at which fluid flow through the axially facing fluid opening and exiting from the fluid outlet opening is permitted. The valve includes a valve poppet and a spring engaged with the valve poppet that biases the valve poppet to the first position. The valve poppet and the removable sleeve are configured such that a flow path is defined between the valve poppet and the sleeve when the valve poppet is at the second position thereby permitting fluid flow through the axially facing fluid opening and exiting from the fluid outlet opening.

The poppet can include a hole defined therein that is configured to receive the end of the pin on the filter cartridge. In addition, the spring can be a coil spring that surrounds a portion of the valve poppet. The pin extending into the hole and the coil spring surrounding the valve poppet help to stabilize the valve poppet and prevent lateral side-to-side movement or flutter of the valve poppet.

### DRAWINGS

FIG. 1 is an exploded cross-sectional view of the filter assembly.

FIG. 2 is a cross-sectional side view of a filter assembly with an installed filter cartridge described herein.

FIG. 3 is a cross-sectional side view of the filter head of the filter assembly of FIG. 1.

FIG. 4 is a perspective view of the upper endcap of the inner filter element of the filter cartridge.

FIG. 5A is a side view of the upper endcap of the inner filter element of the filter cartridge.

FIG. 5B is a cross-sectional side view of the upper endcap of the inner filter element of the filter cartridge.

FIG. 6 is a detailed view of a valve assembly that is disposable in the filter head, with the valve of the valve assembly at the first or closed position.

### DETAILED DESCRIPTION

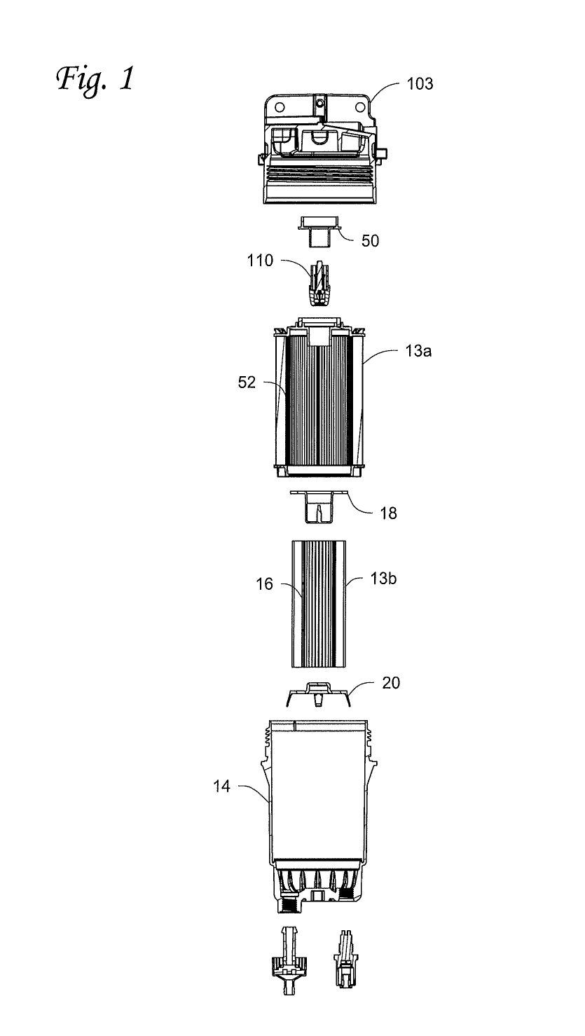

FIGS. 1-3 illustrates an assembly 10 that includes a filter cartridge 12 disposed within a filter housing 14. The assembly 10 can be, for example, used in a fuel system for filtering fuel, for example diesel fuel, before the fuel reaches a protected system, for example a fuel injection pump or fuel injectors. While this description will hereinafter describe the filter cartridge and filter housing as being used to filter fuel, it is to be realized that the concepts described herein can be used for other fluids. For example, in appropriate circumstances, one or more of the concepts described herein can be applied to other types of assemblies that filter other types of fluids, for example lubrication, hydraulic and other liquids, as well as air.

In the example described herein, the filter cartridge 12 is configured to filter fuel. In addition, the filter cartridge 12 is illustrated as a dual-stage, filter-in-filter style filter cartridge having an outer filter element 13a and an inner filter element 13b. Further details on a filter-in-filter style filter cartridge can be found in U.S. Application Ser. No. 11/937,700. Alternatively, the filter cartridge 12 can be a single-stage type filter cartridge with a single filter element, and the concepts of the filter cartridge described herein apply equally well to a single-stage type filter cartridge.

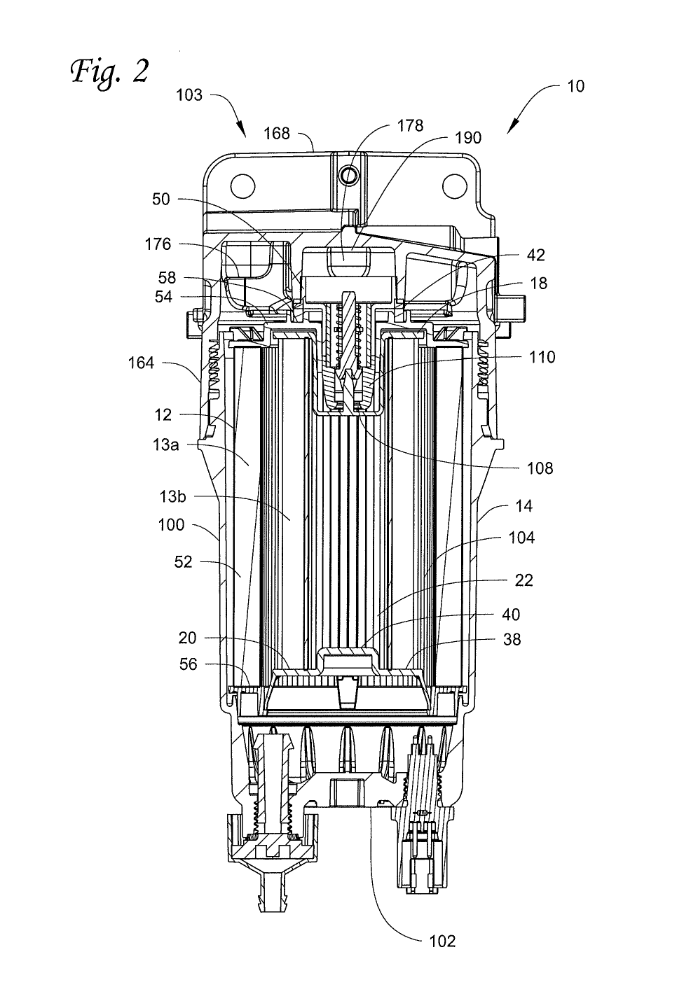

With reference to FIGS. 1 and 2, the inner filter element 13b of the filter cartridge 12 includes filter media 16, an upper endcap 18 secured to an upper end of the media 16, and a bottom endcap 20 secured to a bottom end of the media 16. The ends of the filter media 16 are secured to the endcaps 18, 20 in any suitable manner, for example embedding the media into the endcaps or by using an adhesive to adhere the media to the endcaps. The endcaps 18, 20 can be made of, for example, a plastic material or other material compatible with the fuel or other fluid being filtered.

The filter media 16, which in the illustrated example is a cylindrical ring in lateral cross-section, defines an interior space 22. The filter media 16 can take on any lateral cross-sectional shape, for example the cylindrical ring, triangular, oval, as long as it defines interior space 22. In the example described herein, the interior space 22 defines a clean fuel side that receives filtered fuel that has been filtered by the media 16, in which case the filter cartridge 12 is configured for outside-in flow. The filter cartridge 12 could also be constructed for inside-out flow, in which case the interior space 22 is the dirty fuel side and fuel flows outwardly through the filter media 16 toward a clean fuel side.

The filter media 16 is designed to remove unwanted contaminants from the fuel. For example, the filter media 16 can be configured to remove soft and solid particulate contaminants and/or water from the fuel. A person of ordinary skill in the art would know the appropriate filter media to use for filtering the fuel or other fluid.

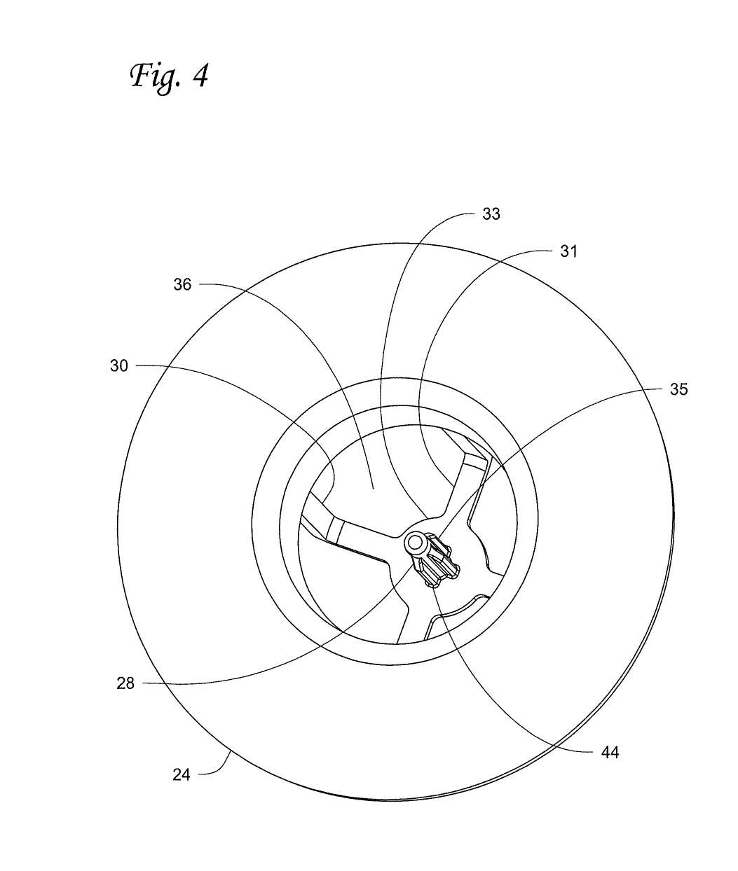

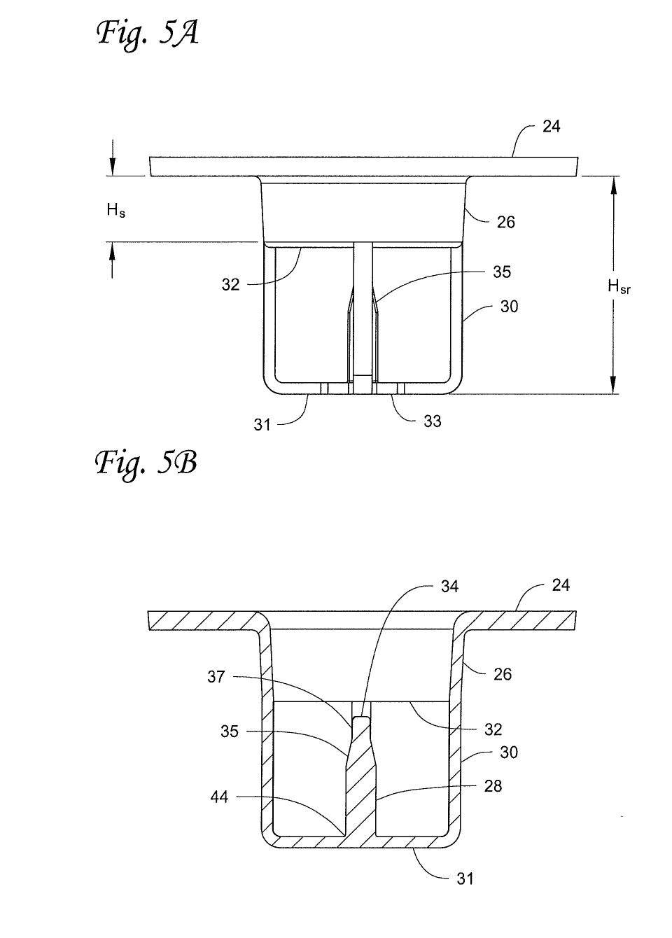

With reference to FIGS. 4 and 5A-B, the upper endcap 18 includes a generally circular, horizontal, planar disk portion 24 with an annular perimeter portion that is attached to the upper end of the filter media 16. An annular skirt 26 extends axially downward from the disk portion 24 toward and into the interior space 22. A plurality of vertical ribs 30 extend generally axially downward from base ends where they connect to the bottom edge 32 of the annular skirt 26 toward and into the interior space 22 to distal ends. The vertical ribs 30 are generally rectangular in shape. A plurality of horizontal ribs 31, also being generally rectangular in shape, extend generally radially inward from the distal ends of the vertical ribs 30 ends toward their radially inner ends that are adjoined to each other at a central joint 33 at the central longitudinal axis of the endcap 18. The central joint 33 can be of various shapes. In the illustrated example, the central joint is in a shape of a circular plate having the same thickness as the horizontal ribs 31.

The vertical ribs 30 and horizontal ribs 31 are circumferentially spaced from each other, defining fluid flow channels 36 therebetween. In the illustrated example, the height Hs of the skirt 26 is about ⅓ of the total height Hsr of the skirt 26 and the vertical ribs 30, as shown in FIG. 5A. However, the ratio between the heights Hs and Hsr can vary as long as the skirt provides sufficient strength to support ribs 30, 31 and the flow channels 36 provide sufficient space for the fuel to flow through.

In addition, the endcap 18 includes a pin 28 that extends axially upward away from the interior space 22. The pin 28 is illustrated as being substantially centrally disposed along the central axis of the endcap 18 and along the central axis of the filter media 16. However, in another example the pin can be offset from the central axis. Further, although only a single pin is illustrated, multiple pins can be used. When multiple pins are used, at least one pin would be offset from the central axis of the filter media.

The pin 28 includes a base end 44 that is connected to an upper surface of the central joint 31 and extends generally axially upward from the base end to an axially distal or free end 34. The distal or free end 34 does not extend past the bottom edge 32 of the skirt 26, as shown in FIGS. 2 and 5B. In the example illustrated, the pin 28 has a generally “+” (plus) or cross shape when viewed in lateral cross-section due to transition sections 35 extending from the ribs 30. The transition sections 35 help reinforce and stiffen the pin 28, to prevent deformation and/or breakage of the pin 28. The transition sections 35 taper in size as they extend toward the free end 34, with the sections 35 stopping short of the free end 34 leaving a portion 37 of the pin 28 that is devoid of the transition sections 35 and thus not having the generally “+” (plus) or cross shape. The portion 37 is generally circular in lateral cross-section and has a substantially constant diameter from where the sections 35 end to the free end 34.

However, other pin shapes can be used as long as the pin(s) can cooperate with and actuate the valve as discussed below. The pin(s) can also take the form of ribs, teeth or any type of protrusion capable of cooperating with and actuating the valve. Thus, as used herein, a pin is intended to encompass a protrusion like that illustrated in FIGS. 2, 4 and 5B, as well as ribs, teeth, or other protrusions capable of cooperating with and actuating the valve in a manner similar to the pin 28 described herein.

In the illustrated example, the skirt 26, the pin 28 and the ribs 30 are integrally formed with the endcap 18. However, one or more of these features can be non-integrally formed with the endcap 18. For example, the pin and the ribs can be part of an assembly that is formed separately from the endcap 18, and thereafter secured to the endcap 18, for example via a snap fit or welded connection of the assembly to the skirt 26.

As shown in FIG. 2, the bottom endcap 20 includes a generally planar lower annular portion 38 that is attached to the bottom end of the filter media 16 and a generally circular upper portion 40. The bottom endcap 20 closes the bottom portion of the interior space 22. The bottom endcap 20 is devoid of an opening for a standpipe to extend therethrough. The specific configuration of the bottom endcap 20 is not critical to the concepts described herein, and numerous configurations are possible.

With reference to FIGS. 1 and 2, the outer filter element 13a of the filter cartridge 12 includes filter media 52, an upper endcap 54 secured to an upper end of the media 52 and closing the upper end, and a bottom endcap 56 secured to a bottom end of the media 52. The ends of the filter media 52 are secured to the endcaps 54, 56 in any suitable manner, for example embedding the media into the endcaps or by using an adhesive to adhere the media to the endcaps. The endcaps 54, 56 can be made of, for example, a plastic material or other material compatible with the fuel or other fluid being filtered. The upper endcaps 54 and 18 of the outer and inner filter elements 13a, 13b are sealed by, e.g., interference fit between the upper endcaps 54 and 18, preventing leakage of the fuel, which has been filtered by the outer filter element 13a but has not yet been filtered by the inner filter element 13b, to the interior space 22. It is to be understood that various other sealing methods can be used to seal between the upper endcaps 54 and 18. The upper endcap 54 of the outer filter element 13a further includes a groove 58 defined by two coaxial radial ribs extending upward from the top surface of the upper endcap 54.

The illustrated example of the filter housing 14 includes a housing body that has a side wall 100 and an end wall 102. The side wall 100 and the end wall 102 define a filter cartridge space 104 that is large enough to receive the filter cartridge 12 therein, with the end wall 102 forming a closed end of the space 104. The housing body has an open end generally opposite the end wall, with the open end in use being closed by a filter head 103 that closes off the space 104.

The filter head 103 is adapted to engage the housing 14 to close the open end of the housing 14 by, for example, threaded connection. As used herein, the filter head 103 is any structure that is designed to close the open end of the filter housing 14, allows fuel to be filtered to enter the filter assembly 10, allows filtered fuel to exit the filter assembly, and that has any of the other functions of the filter head 103 illustrated and described herein. For example, the filter head 103 is used to mount the filter assembly 10 in place in the filtration system for a spin-on filter. The filter head is not limited to the structure as illustrated in FIGS. 1-3. It can have other configurations not specifically illustrated.

As shown in FIGS. 1-3, the filter head 103 includes a cylindrical side wall 164 configured to be attached to the upper end of the sidewall 100 of the housing to close the open end of the housing 14. The filter head 103 also includes a top wall 168 defining a central hub 172 on the bottom surface thereof and a fuel inlet opening 176 between the hub 172 and the side wall 164 of the filter head 103. Any shapes suitable for use with the disclosed assembly can be used for the fuel inlet opening 176. The central hub 172 defines a fuel outlet channel 178 extending from the interior space 22 upwardly to a fuel outlet opening 190, through which the filtered fuel exits on its way to the engine. It is to be realized that the filter housing 14 could have other configurations than that described herein.

The unfiltered fuel flows between the space between the inner surface of the housing body and the outer surface of the outer filter element 13a, past the filter media 52 and enters the space between the outer filter element 13a and the inner filter element 13b. The fuel flows further past filter media 16 and enters the interior space 22 defined by the inner filter element 13b. As illustrated, a fuel flow passage is formed between the inner surface of the housing body and the outer surface of the outer filter element 13a in communication with the fuel outlet opening 190 so that fuel that enters the housing 14 can flow past the filter media 52 and 16 and into the fuel outlet opening 190 to the engine.

The central hub 172 is configured to receive a removable sleeve 50. The removable sleeve 50 is configured to connect the central hub that is currently used in spin-on filters on the market and a valve assembly 110 for controlling the flow of fuel into the central hub 172. The removable sleeve 50 includes an upper sleeve 184 and a lower sleeve 186, where the outer diameter of the upper sleeve 184 is sized to be received by the central hub 172 and the inner diameter of the lower sleeve 186 is sized to receive the valve assembly 110. The upper sleeve 184 is retained in the hub 172 by an interference fit and/or using auxiliary means such as adhesive. The interference fit between the hub 172 and the upper sleeve 184 also helps prevent fluid leakage between the surfaces. It is to be understood that various other sealing methods can be used to prevent the leakage between the surfaces.

When the upper sleeve 184 is received in the central hub 172, the removable sleeve 50 is centrally disposed on the bottom side of the filter head 103 coaxial with the central axis of the filter head 103. As illustrated, when the valve assembly 110 is in an open position, the interior space 22 is in communication with the fuel outlet opening 190 so that fuel that enters the interior space 22 can flow through the valve assembly 110, past the central sleeve 50 and into the fuel outlet opening 190 to the engine. Fuel enters the central sleeve 50 through an axially facing opening 108 at the bottom end thereof that places the fuel outlet channel 178 in communication with filter cartridge space 104, particularly the interior space 22 defined by the inner filter element 13b.

In the example as illustrated and described, the upper sleeve 184 has larger respective outer and inner diameters than the outer and inner diameters of the lower sleeve 186. The removable sleeve 50 further includes a peripheral lip 192 extending radially outward and protruding over the wall of the central hub 172 to prevent unfiltered fuel from entering the interior space 22. A gasket ring 42 is received in the groove 58 defined on the top surface of the upper endcap 54 of the outer filter element 13a. The gasket ring 42 extends upward to seal on the peripheral lip 192 for sealing engagement. In an alternative embodiment, the removable sleeve 50 does not include the peripheral lip 192 and the gasket ring 42 extends upward and sits directly on the bottom end of the central hub 172 for sealing engagement. It is to be understood that various other sealing methods can be used to seal the removable sleeve 50 to filter head 103 and/or the top surface of the upper endcap 54.

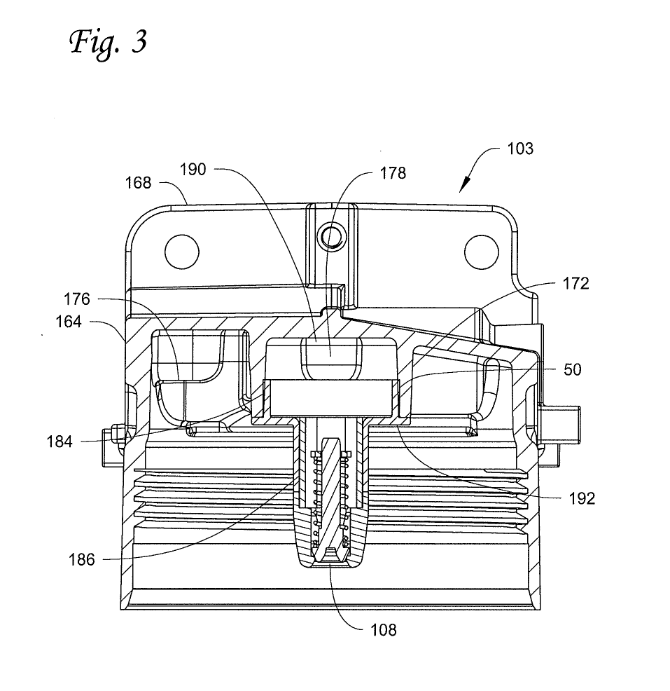

In the example as illustrated in FIGS. 2 and 3, the thickness of the wall of the upper and lower sleeves 184, 186 and the thickness of the peripheral lip 192 remain constant. The specific configuration of the removable sleeve 50, including the upper sleeve 184, the lower sleeve 186, the peripheral lip 192 and the gasket 42, is not critical to the concepts described herein, and numerous configurations are possible, as long as the removable sleeve 50 communicates the fuel outlet channel 178 with the interior space 22 and means are provided (either on the filter head 103, the top surface of the upper endcap 54 and/or on the removable sleeve 50) for preventing leakage.

As used herein, the axially facing opening 108 or the like is a fluid opening that faces generally in the direction of insertion/removal of the filter cartridge into/from the filter assembly. As in the example illustrated herein, the filter assembly 10 is a bottom loaded filter assembly. That is, when the filter cartridge 12 is to be replaced, the housing body is removed from the filter head 103, while the filter head 103 remains mounted to the engine, chassis, or application. After the used filter cartridge is removed and a new filter cartridge is loaded in from the top of the housing body, the housing body with new filter cartridge is placed back and attached to the filter head. The axially facing opening 108 need not be oriented perpendicular to the insertion/removal direction as is illustrated. Instead, an axially facing fluid opening 108 is intended to encompass any orientation of the opening 108 relative to the insertion/removal direction that allows the pin 28 to extend therethrough and cooperate with and actuate the valve assembly 110 as described herein.

The axially facing opening 108 is illustrated as being disposed along the central axis of the filter head 103 and along the central axis of the filter media 16, with the center of the opening 108 coaxial with the central axis. In another example, the axially facing opening 108 can be offset from the central axis so that the center of the opening 108 is offset from the central axis. When the opening 108 is offset, the central axis could nonetheless extend through the opening 108 or the opening 108 could be configured and arranged such that the central axis does not extend through the opening 108. Further, while a single opening 108 is illustrated, multiple openings 108 can be provided if a single or a plurality of pins 28 are provided. In another example, a single opening 108 could accommodate multiple pins.

Therefore, the number of pins 28 and their location(s), orientation(s) and configuration(s), and the number of openings 108 and their location(s), orientation(s) and configuration(s), can vary as long as the pin(s) can extend through the opening(s) 108 to cooperate with and actuate the valve.

The valve assembly 110 is disposed at the bottom end of the removable sleeve 50 to control the flow of fuel into the sleeve. The valve assembly 110 is configured to prevent fuel flow into the sleeve 50 and/or hub 172 when the filter cartridge 102 is not installed or when an incorrect filter cartridge is installed. With reference FIGS. 2-3 and 6, the valve assembly 110 includes a first portion 112 and a second portion 114 that are connectable together during assembly and insertable into the bottom end of the removable sleeve 50 to define the bottom end of the sleeve. When inserted, the valve assembly 110 is retained in the sleeve by an interference fit and/or using auxiliary means such as adhesive, and forms the bottom end of the sleeve. The first and second portions 112, 114 of the valve assembly 110 can be made of, for example, plastic.

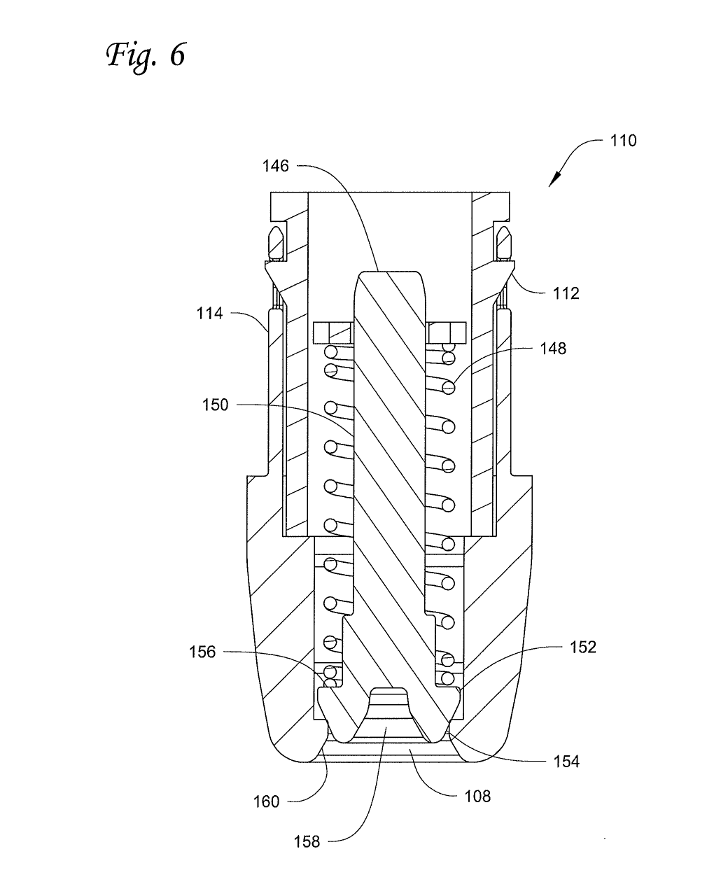

With reference to FIG. 6, the first portion 112 comprises a generally tubular body with an outer perimeter shape and dimension that is slightly less than the inner perimeter surface of the bottom end of the sleeve 50 so that the first portion 112 is receivable within the bottom end via a relatively close interference fit. The outer perimeter shape of the tubular body can vary, e.g., having a circular or oval cross section. The inner perimeter shape of the tubular body may track the outer perimeter shape of the tubular body. Alternatively, the inner perimeter has its own shape and does not track the outer perimeter shape of the tubular body. The inner perimeter shape of the tubular body can vary, e.g., having a circular or oval cross section.

The axially facing opening 108 is defined at the bottom of the second portion 114. The opening 108 can be any shape that allows passage of the pin 28 and that allows fuel to flow therethrough. For example, the opening 108 can be circular, oval, etc.

As illustrated in FIG. 6, the valve assembly 110 further comprises a valve poppet 146 and a biasing spring 148. The poppet 146 includes a stem 150 and a valve head 152. The valve head 152 is generally mushroom-shaped with an angled lower surface 154 that extends radially outward and upward from a bottom surface, and a top surface 156 that extends radially inward from the angled surface 154. The poppet 146 includes a hole 158 defined therein that is open axially downward and extends from the valve head 152 upward toward the stem 150. In use, the hole 158 receives the portion 37 of the pin 28 as shown in FIG. 2.

The spring 148 is illustrated as a coil spring that surrounds the stem 150, with one end of the spring 148 engaged with the top surface 156 of the valve head 152. The other end of the spring 148 is engaged with the first portion 112.

The valve poppet 146 is axially movable between a first, sealing position (shown in FIG. 3) and a second, open position shown in FIG. 2. As shown in FIGS. 3 and 6, when no filter is installed or an appropriately designed filter cartridge is not installed, the valve poppet 146 is normally biased downward to the first position where the angled surface 154 of the valve head 152 is in sealing engagement with a valve seat 160 defined around the axially facing opening 108. At the first position, fuel flow through the inlet opening 108 and into an outlet passage of the filter assembly 10 is prevented.

Upon installation of an appropriately designed filter cartridge, for example the filter cartridge 12, the pin 28 extends through the opening 108 and into the hole 158 and actuates the valve poppet to the second position shown in FIG. 2. At the second position, fuel is permitted to flow through the axially facing fluid opening 108 and into the sleeve. The pin 28 extending into the hole 158 together with the coil spring 148 surrounding the stem 150 help to stabilize the poppet 146 and prevent lateral side-to-side movement or flutter of the poppet 146.

The pin 28 and the opening 108 need to be configured to provide sufficient flow passage area to allow sufficient amount of fuel to flow into an outlet passage of the filter assembly 10 for engine operation. To permit fuel flow when at the second position, the valve poppet 146 and the first portion 114 of the valve assembly 110 are configured to define a fuel flow path between the valve poppet and the first portion 114. Further details on a valve assembly can be found in U.S. application Ser. No. 12/434,863.

The pin 28 is illustrated as being substantially solid. However, it is contemplated that the pin 28 could have one or more flow passages defined therein that contribute to creating the flow passage area for the fuel.

Other variations of the valve assembly 110 are possible. For example, any configuration can be used where the bottom end of the sleeve includes an axially facing opening, a valve (for example the poppet 146 and bias spring 148), and a suitable configuration of the valve poppet and the sleeve such that a flow path is defined between the valve poppet and the sleeve when the valve poppet is at the second position thereby permitting fluid flow through the axially facing fluid opening and into the internal flow passage.

The valve assembly 110 need not include the two portions 112, 114. Instead, the first portion 112 could be eliminated, and a suitable retainer can be formed integrally with or installed into the second portion 114 for retaining the top end of the spring. In this example, the top end of the second portion would be suitably configured to achieve the interference fit with the inner surface of the bottom end of the sleeve.

It is to be understood that the central hub 172 need not include the removable sleeve 50. Instead, the removable sleeve 50 can be eliminated, and the central hub 172 can be constructed with a reduced diameter to receive the valve assembly 110 directly. In this example, the bottom end of the central hub 172 would be suitably configured to achieve the interference fit, and/or using auxiliary means such as adhesive, with the top end of the valve assembly 110. The interference fit between the valve assembly 110 and the filter head 103 also helps prevent fluid leakage between the surfaces. It is to be understood that the valve assembly 110 can be retained to the filter head 103 via other fastening mechanisms, e.g., bolts and seal, threaded engagement, etc.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A filter cartridge, comprising:
a filter media defining an interior space, and having a first end and a second end;
a first endcap at the first end, the first endcap includes a planar section that is connected to the first end of the filter media, and the first endcap being devoid of a central opening; and
a second endcap at the second end, the second endcap includes a planar section that is connected to the second end of the filter media and a fluid passageway, a pin connected to the second endcap, the pin having a fixed end and a free end, the fixed end of the pin is disposed within the interior space, and the free end is positioned further away from the first endcap than is the fixed end.

2. The filter cartridge of claim 1, further comprising a skirt extending axially from the second endcap into the interior space and a plurality of ribs extending from a bottom edge of the skirt into the interior space and adjoining with each other at a central joint, the plurality of ribs being spaced from each other and defining fluid flow channels therebetween.

3. The filter cartridge of claim 2, wherein the pin is connected to and extends away from the central joint and the free end of the pin stops short of the bottom edge of the skirt.

4. The filter cartridge of claim 3, wherein the pin has a cross-shaped portion that terminates short of the free end and a constant diameter portion that extends from the cross-shaped portion.

5. The filter cartridge of claim 1, wherein the filter media includes a central axis, and the pin is disposed along the central axis.

6. The filter cartridge of claim 1, wherein the filter media is configured for filtering fuel, hydraulic fluid, lubrication fluid or air.

7. The filter cartridge of claim 1, wherein the planar section of the second endcap defines an opening that leads to the interior space, the opening being oval or circular.

8. A filter assembly, comprising:
a housing body having a closed end, an open end and a side wall extending from the closed end to the open end;
threads on an exterior surface of the side wall adjacent the open end;
a filter head that includes a side wall with threads on an inner surface thereof that are engageable with the threads on the exterior surface, the filter head includes an interior space that is divided into a first space for unfiltered fluid and a second space for filtered fluid, an inlet in the filter head in communication with the first space, and an outlet in the filter head in communication with the second space; and
the filter assembly also includes an outlet flow passage for filtered fluid, the outlet flow passage is in communication with the second space and has a valve that controls fluid flow through the outlet flow passage.

9. The filter assembly of claim 8, further comprising a filter cartridge that includes:
a filter media defining a space and having a first end and a second end;
an endcap disposed at the second end of the filter media, and
a protrusion connected to the endcap and positioned to actuate the valve, the protrusion having a fixed end and a free end, the fixed end of the protrusion is disposed within the space, and the free end is positioned further away from the first end of the filter media than is the fixed end.

10. The filter assembly of claim 9, wherein the filter head further includes a hub, the valve is connected to the hub, and the valve includes an axially facing opening through which the protrusion is extendable in order to actuate the valve.
wherein, and the valve poppet and the removable sleeve are configured such that a flow path is defined between the valve poppet and the removable sleeve when the valve poppet is at the second position thereby permitting fluid flow through the axially facing opening and into the outlet flow passage.

11. The filter assembly of claim 10, wherein the valve includes a valve poppet and a spring engaged with the valve poppet that biases the valve poppet to a closed position, and the valve poppet includes a hole defined therein that is configured to receive an end of the protrusion on the filter cartridge.
